(19) United States
(12) Patent Application Publication
(10) Pub. No.: US 2015/0042959 A1
(43) Pub. Date: Feb. 12, 2015

(54) PANORAMA PROJECTION UNIT WITH HOUSING FOR A MOTOR VEHICLE

(71) Applicant: GM GLOBAL TECHNOLOGY OPERATIONS LLC, Detroit, MI (US)

(72) Inventors: David Leary, Warwickshire (GB); Borris Ilse, Mainz (DE); Boris Jacob, Wiesbaden (DE); Jong Won Kim, Frankfurt (DE); Lionel Silva Santos, Ruesselsheim (DE); Martin Golly, Saulheim (DE); Ivo van Hulten, Frankfurt (DE); Martin Schaufler, Mainz (DE)

(21) Appl. No.: 14/458,064

(22) Filed: Aug. 12, 2014

(30) Foreign Application Priority Data
Aug. 12, 2013 (DE) 202013007158.3

(51) Int. Cl. G03B 37/00; G03B 21/20; G03B 21/16; B60Q 3/02; G03B 21/10

(52) U.S. Cl. CPC G03B 37/00; B60Q 3/02; G03B 21/10; G03B 21/16; G03B 21/2033
USPC 353/13

(57) ABSTRACT

A panorama projection unit is disclosed which concentrates the projected images in a front area of the motor vehicle and temporarily or locally shades the projection beams between projection units and the display surfaces. The panorama projection unit includes a transparent panoramic pane, and a plurality of projectors arranged in the housing. The arrangement of the projectors is configured to project images onto a rear side of the panoramic screen.

### CROSS REFERENCE TO RELATED APPLICATION

This application claims priority to German Patent Application No. 202013007158.3 filed Aug. 12, 2013, which is incorporated herein by reference in its entirety.

### TECHNICAL FIELD

A panorama projection unit with housing for a motor vehicle is described.

### BACKGROUND

In general motor vehicles include display devices which normally are vacuum fluorescence displays (VFD) or liquid crystal displays (LCD) for displaying operational data. Such display devices show for example the state of safety components such as electronic safety assistants or comfort devices of the vehicle which indicate seat adjustment, seat heating, window lifters, external mirror settings or other infotainment components, including for example a navigation system or a car radio.

The specification EP 1 798 588 B1 has further disclosed a control system to control functions in a motor vehicle. To this end different display surfaces and display devices are provided in different positions inside the vehicle. The display devices are used for the graphic display of images and virtual control elements on surfaces inside the vehicle. Detection units detect operator entries when the virtual control elements are actuated. A control device is data-connected with the detection units and the display devices on the different display surfaces for displaying the virtual control elements in dependence of the detected operator entries. To this end projection units are distributed throughout the inside of the vehicle, and these project pictures of the images and the control elements onto a projection surface from different projection angles.

Due to the plurality of images and information which can be visually displayed, conventional dashboards equipped with such imaging devices become cluttered or may divert the attention of a driver from essential information such as the traffic. Therefore, display devices and images are provided in the vehicle which produce a virtual picture visible for the viewer in the area of the windscreen. Such devices are called head-up displays (HUDs).

These known display devices require a considerable amount of installation space in a motor vehicle. Moreover the plurality of vehicle functions to be controlled together with their associated images and control elements on virtual and real screens leads to a confusing overall layout which may be distracting to the driver due to the complexity and multitude of images and control elements during actuation of such control elements.

### SUMMARY

In accordance with the present disclosure, a panorama projection unit is provided which concentrates the projected images in a front area of the motor vehicle and temporarily or locally shades the projection beams between projection units and the display surfaces. The panorama projection unit described herein reduces the error rate of conventional systems and achieves improved creative freedom in the arrangement and the display of imaging and control functions.

One embodiment of the present disclosure is a panorama projection unit with a housing with a three-dimensional panoramic screen, which includes a transparent panoramic pane, and a plurality of projectors arranged in the housing. The arrangement of the projectors is configured to project images onto a rear side of the panoramic screen. In one embodiment the transparent three-dimensional panoramic pane is provided with a semi-transparent rear side coating. As such, the panorama projection unit has the advantage that the projection beams can no longer be influenced and disturbed by the vehicle occupants or the driver inside the vehicle because the projectors are arranged behind the panoramic screen exposed towards the interior space of the vehicle. The imaging system with its projection beams is thus completely shielded from the driver and passenger inside the vehicle. A further advantage includes the possibility of providing each projector with its own housing, by accommodating a group of projectors in one housing or by providing a large housing for the entire panorama projection unit.

In one embodiment, the housing is adapted in its width to the internal front width of the vehicle, and the housing is limited in direction of the vehicle interior space. In a further embodiment, the housing is configured as a slide-in cassette thus wholly or partially forming a dashboard or replacing a conventional dashboard. One advantage of this embodiment is that a conventional dashboard can be omitted, and that the many different instruments, device indicators, displays etc. arranged in a conventional dashboard can be omitted, and incorporated in the slide-in cassette, which in direction of the interior of the vehicle presents a uniform front in the form of a panoramic screen. In this embodiment, the slide-in cassette is hidden beneath the water channel of the vehicle, and only the panoramic screen extends like a dashboard into the front area of the vehicle interior space. To this end, provision is made in one embodiment, for the housing to be arranged on a rack so as to be protected against vibration. The rack itself can be of solid construction and dampened against vibration relative to the body work, so that a reproducibly vibration-proof coupling inside the slide-in cassette between projectors and panoramic screen is ensured in all operating situations of the vehicle.

In another embodiment, the individual projectors are rigidly fixed to the rack together with the panoramic screen, while the housing itself is made merely from deflector plates for the admittance of cooling air and is supported against the vehicle chassis. In any case, no matter whether with a surrounding vibration-dampened housing or with a separate non-dampened housing, the alignment of the projection beams with the projection surfaces of the panoramic screen is ensured. A panorama projection unit of this type has the advantage that the projection beams can no longer be influenced or disturbed by the vehicle occupants or the driver in the vehicle interior space because the projectors are arranged behind the panoramic screen exposed towards the vehicle interior space. The imaging system with its projection beams is thus completely shielded from the driver and passengers inside the vehicle. A further advantage includes the elimination of numerous conventional indicating, displaying and control devices due to the large panoramic screen covering the whole of the vehicle internal width. On the one hand this results in spatial advantages for the manufacturer and on the other, in improved creative freedom and reduced manufacturing costs as well as considerable weight savings. Instead of many separate small indicating devices and projection surfaces, one large panoramic screen of lightweight construction now takes over the imaging functions and/or control functions.

A further advantage includes a virtual display of the respectively momentarily desired images and control elements, thereby eliminating conventional physical arrangement of all available images and control elements. This would have the effect of making the layout of the entire dashboard area of the vehicle clearer, which also gives the manufacturer greater creative freedom. Besides, any amount of vehicle functions can be clearly displayed by individual control symbols or control elements by means of the rear-side projectors, because only the symbols and control elements momentarily needed or very probably just about to be selected can be displayed on the panoramic screen. The images and/or control elements probably not needed are not shown and therefore do not require any additional space in the front area of the vehicle. Finally it is a fact that projectors of this kind are now available which are very low weight and which include small packaging volumes. It is expected that packaging volumes will reduce still further in the near future due to increasing miniaturization in the field of microelectronics and optoelectronics.

In one embodiment the panoramic screen may include an anti-reflection coating on a front-side face. Such anti-reflection coatings have the effect of completely or at least substantially preventing annoying reflections, which could be caused for example by display coverings or vehicle windows. Due to the interaction between the semi-transparent rear-side coating on the back of the panoramic screen and the anti-reflection coating on the front of the panoramic screen, the panoramic screen is color-shaded in those areas in which no projector happens to be active. The color shading can be selectively set by the manufacturer in order to achieve a pleasing effect upon driver and vehicle occupants. But it is also possible for the driver himself to selectively set the color shading.

Further the panoramic screen may include a transparent plastic material, in particular from polymethylmethacrylate (PMMA) or polycarbonate (PC). Such plastic materials are distinctly lighter than glass or safety glass so that the total weight of all mapped components in the front area of the vehicle can be reduced since these functions are now assumed by the panoramic screen made from a transparent plastic. In principle all types of organic and inorganic glass are suitable.

In a further embodiment of the present disclosure the images are mapped onto the three-dimensional panoramic screen by rear-side projectors in such a way that the three-dimensional panoramic screen shows neither overlapping images nor unused surfaces between the images. A control algorithm is configured to control and/or regulate the mapping areas and transitions of the projection surfaces on the three-dimensional panoramic screen.

In a further embodiment provision is made for the housing to include a cooling air inlet and a cooling air outlet, wherein the cooling air inlet of the housing is connected with a vehicle air conditioning system in order to ensure intensive cooling of the projectors within the housing. Instead of a single slide-in cassette including the entire housing including projectors and panoramic screen, provision may alternatively be made for the housing to include housing modules which are assembled in a modular fashion to form the housing in its totality. With housing modules of this kind, a group of projectors may be enclosed in the housing module, and a corresponding associated modular part of the panoramic screen is connected with the housing module. The entire panoramic screen and the entire panorama projection unit is obtained by assembling the individual housing modules. This can be of advantage, in particular if the panoramic screen is e.g. divided into a left-hand area, a central area and a right-hand area, with these areas being configured as three separate housing modules which are assembled to form the panoramic screen. It is, however, possible to assemble the panoramic screen from more than three, i.e. four or six, separate housing modules.

In a further embodiment of the present disclosure, the projectors form a first projector row arranged in a first housing module, and a second projector row arranged in a second housing module. The first housing module and the second housing module are arranged one above the other. The lower projector row projects onto a lower panoramic screen region and an upper projector row projects onto an upper panoramic screen region. This design has the advantage that the upper panoramic screen region and the lower panoramic screen region can be horizontally displaced relative to one another, thereby automatically resulting in horizontal storage surfaces between the upper panoramic screen region and the lower panoramic screen region. Safety systems such as front airbags, or air conditioning systems may be stowed under the horizontal storage surfaces. The lower panoramic screen region can be arranged so as to be partially spatially offset in relation to the upper panoramic screen region so that sufficient storage space can be obtained for the safety systems.

In a further embodiment of the present disclosure provision is made for the projectors to include light diodes or light diode arrays or laser diodes or laser diode arrays, in particular in the form of Pico beamers. In particular, Pico beamers have very small dimensions and can be integrated in a simple and cost-effective manner with the panoramic screen to form the panorama projection unit. Such projectors of the panorama projection unit may project further images onto the panoramic screen including actual values of predefined vehicle systems such as of a comfort system, of an infotainment system, of a safety system or of the like. Thus, the panorama projection unit includes both an imaging function for mapping system values and control elements which can actuated for activating a mapped function by guiding a finger over contact points or proximity sensors provided on or behind the panoramic screen.

Moreover provision is made, when the vehicle is reversing, for the panorama projection unit to project a video feed from a camera mounted at the rear of the vehicle imaging the external rear area of the vehicle, onto an area of the rear-side of the panoramic screen. Since this projection is required only when the vehicle is reversing, all other images and control elements not necessary for reversing can be temporarily hidden, thus enabling the driver to fully concentrate onto the reversing operation.

In addition, it is possible to project instrument indicators of vehicle speed, engine revolutions, coolant temperature, fuel level, battery state, engine oil temperature, etc. and other driving-related data such as flashing indicator lights, warning indicator lights and/or lighting levels onto an area of the panoramic screen nearest the driver. These projections are best projected on the panoramic screen within the visual range of the driver only when the vehicle is driving forward.

Further, the panoramic screen may be used as a device with partial contact points (touchscreen or proximity sensors) and projected backlit images with menu selection functions and controls affected by a central control unit of images and control elements on the panoramic screen. A central control unit of this kind is provided for a projection of graphic images and control elements in dependence of the detected operator entries by a detection unit and the projection unit. To this end the detection unit and the projection unit are data-connected via respective signal lines and electrically coupled with the vehicle's electric bus system, in particular the vehicle's CAN bus. The central control unit may include one or more digital signal processors (DSPs) or one or more microprocessors (CPUs). In this way changeable images and control elements can be graphically displayed in real time on the common projection surface of the panoramic screen. Several menu levels can be displayed and selected on a separate parameter screen. The central control unit controls the projectors in such a way that new graphic symbols are displayed on the panoramic screen at the menu level associated with the actuated graphic control element. This makes it possible to refer back to stored data records when displaying different images, symbols and/or control elements on the existing panoramic screen. The graphic images and control elements may, at least partially, be provided as changeable images and control elements with a menu level structure. The central control unit, by actuating a predefined virtual control element, controls the projectors of a graphic representation or an control element that may be actuated via respective inferior or superior menu levels.

In one embodiment, the central control unit can control the projectors also for displaying a user-defined menu level with preselected virtual images and control elements. In this respect, the central control unit recognizes the current vehicle driver by the key fob and controls the projection unit for displaying a starter menu level associated with this vehicle driver. It is also possible to display user-defined menu levels with preselected images and control elements in dependence of certain driving situations.

In a further embodiment it is possible for the central control unit to control the projectors for displaying effective images and control elements in dependence of certain momentary driving parameters. For example, when tire slippage is measured the indicating elements for activating the automatic slip control system (ABS) can be displayed. Also when a vehicle accident is detected, emergency call numbers, the warning flashlight symbol and other meaningful images of control elements that may be activated can be displayed by the projectors in the associated areas of the panoramic screen.

At the same time any overload of the panoramic screen is avoided in that only momentarily meaningful and other images and control elements to be very probably selected are displayed to the driver. Besides it is possible for the panorama projection unit to trigger an acoustic, haptic or visual feedback when the provided contact points of virtual control elements are actuated, resulting in the user being informed that his entry has been recognized by the panorama projection unit.

The virtual images and control elements are associated with different vehicle functions. These vehicle functions may e.g. be safety functions, comfort functions, infotainment functions, special functions of special vehicles or other imaginable functions. A menu selection may optionally include communication systems, navigation systems, driver assistance information systems etc. as well as indication and operator selection or voice control.

In a further embodiment of the present disclosure provision is made for the panoramic screen to be fixed between a cross-member of the windscreen and a left-hand A-column and a right-hand A-column of the front area in a vibration-proof manner. The projectors are arranged on a vibration-proof rack anchored between the cross-member and the A-columns in a vibration-dampened manner. The housing includes light metal plates which are supported (undampened) against the vehicle chassis and feed a cooling air current to the projectors.

### BRIEF DESCRIPTION OF THE DRAWINGS

The present disclosure will hereinafter be described in conjunction with the following drawing figures, wherein like numerals denote like elements.

FIG. 1 shows a schematic perspective view of a three-dimensional panoramic screen of a panorama projection unit according to the first embodiment of the present disclosure;

FIG. 2 shows a schematic perspective view of a rigid rack of the panorama projection unit according to the first embodiment of the present disclosure;

FIG. 3 shows a schematic view of a panorama projection unit according to a first embodiment of the present disclosure in detail including a control unit;

FIG. 4 shows a schematic housing design of a panorama projection unit according to a second embodiment of the present disclosure;

FIG. 5 shows a schematic view of a panorama projection unit according to a further embodiment of the present disclosure;

FIG. 6 shows a schematic view of a panorama projection unit according to a further embodiment of the present disclosure; and

FIG. 7 shows a schematic perspective view of a panorama projection unit according to a further embodiment of the present disclosure with an “information center” including images and control elements of a communication system.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

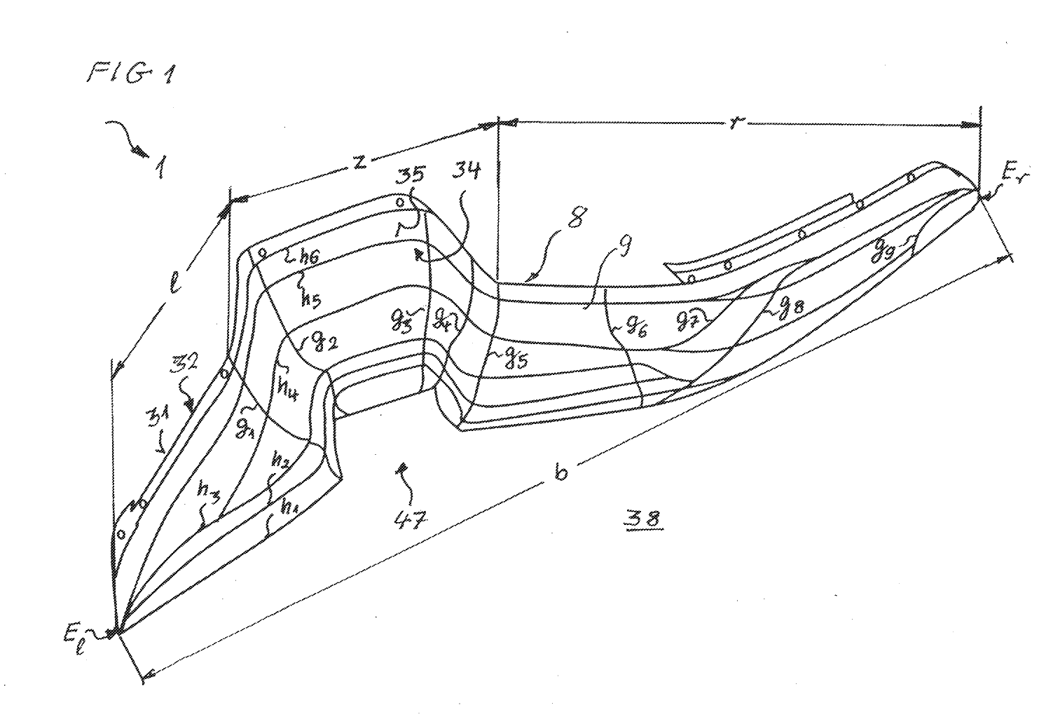

FIG. 1 shows a schematic perspective view of a three-dimensional panoramic screen 8 of a panorama projection unit 1 in a front area 47 of a vehicle interior space 38. The panoramic screen 8 according to a first embodiment of the present disclosure includes a width b which corresponds to the internal front width of a vehicle. The panoramic screen 8 is composed of three areas, a left-hand area (l) arranged to the left of a steering column not shown, a central area (z) with an indentation for a steering column within the visual range of the driver, and a right-hand area (r) arranged to the right of the steering column not shown and fully within the visual range of a passenger.

Contour lines h₁, h₂, h₃, h₄, h₅ and h₆ indicate the spatial three-dimensional shape of the panoramic screen 8. Furthermore border lines g₁-g₉ can be seen which limit individual areas of the panoramic screen 8. Thus, the left-hand area (l) extends from a left end Eₗ to a first border line g₁. The central area (z) extends from the border line g₁ to the border line g₅. The right-hand area (r) extends from the border line g₅ to the right-hand corner Eᵣ of the panoramic screen 8. A panoramic screen 8 of this kind may also be composed of three single areas l, z and r.

The panoramic screen 8 shown in FIG. 1 has a front side 35 to which an anti-reflection coating 34 has been applied. An anti-reflection coating of this kind has a thickness lying within the micrometer range and this ensures that the images on the panoramic screen 8 are not impaired neither through window reflections nor through reflections from a covering. Further, the panoramic screen 8 includes a transparent panoramic pane 9 and manufactured from a transparent plastic such as polymethylmethacrylate (PMMA) or polycarbonate (PC), having a rear-side 31 provided with a semi-transparent rear-side coating 32. The semi-transparent rear-side coating 32 prevents that the projectors (not shown in FIG. 1) which irradiate the rear side 31 of the panoramic screen 8 can be recognized from the front side 35.

The entire surface of the panoramic screen 8 appears almost uniformly opaque when the projectors directed at the rear-side 31 are switched off. Both the anti-reflection coating 34 on the front side 35 and the rear-side coating 32 on the rear-side 31 can ensure that the panoramic screen appears to the viewer as if it were colored. For example, a silicon dioxide layer deposited on the front side 35 with a thickness between 0.1 and 0.8 μm can cause the surface of the panoramic screen 8 to appear blue, green, yellow or orange. Also finely distributed color pigments in the rear-side coating 32 on the rear-side 31, which do not impair the image projected on the back, can produce a predefined color effect for the viewer of the panoramic screen, when the projectors are switched off.

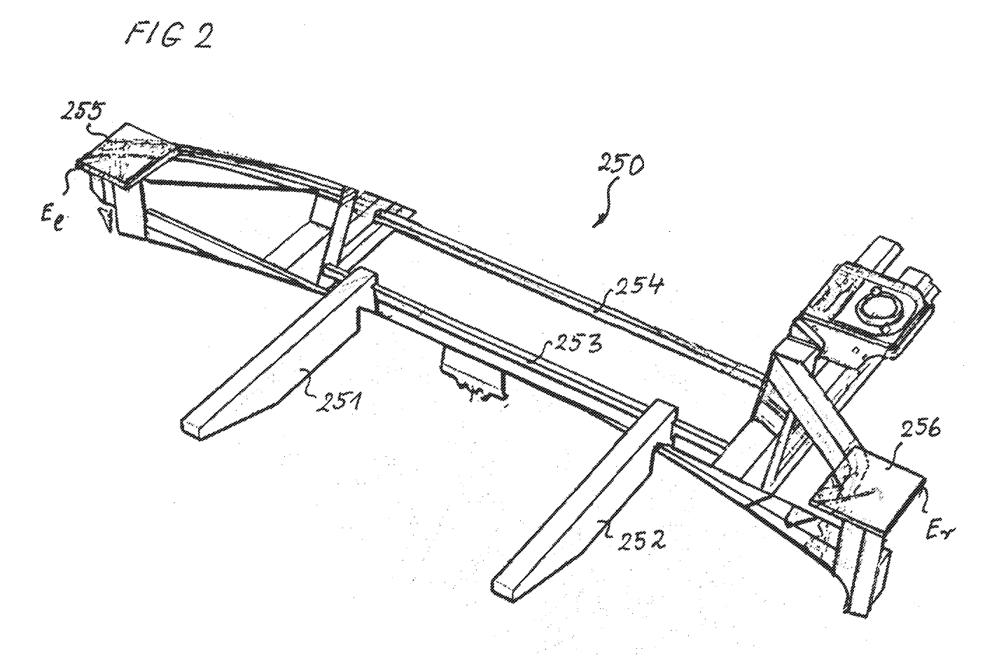

FIG. 2 shows a schematic perspective image of a rigid rack 250 of the panorama projection unit according to one embodiment. The rigid rack 250 includes two longitudinal members 251 and 252 which support a panoramic screen 8 of the kind shown in FIG. 1 and described above. Furthermore the rack 250 includes a first cross-member 253 and a second cross-member 254 to which the projectors of the panorama projection unit can be attached. A first left-hand end region 255 of the rack receives the end Eₗ of the panorama projection unit of FIG. 1, and a second right-hand end region 256 of the rack receives a right-hand end Eᵣ of the panorama projection unit as shown in FIG. 1. Thus, all components of the panorama projection unit are fixed on or to the rigid rack 250, with the result that both the panoramic screen and the projectors are rigidly mounted and therefore mapping errors cannot occur.

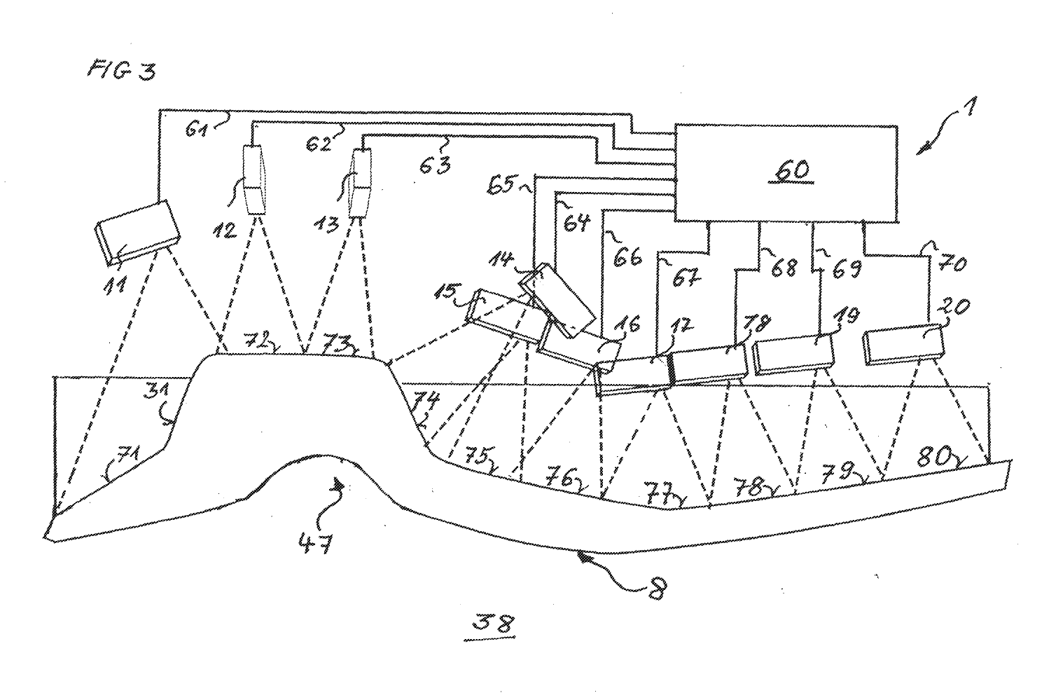

FIG. 3 shows a schematic view of a panorama projection unit 1 according to one embodiment. In FIG. 3 only the outline of the panoramic screen 8 and the projectors 11-20 arranged behind the panoramic screen 8 are shown. The projectors 11-20 direct their beams onto the rear-side 31 of the panoramic screen 8 and form projection surfaces 71-80. The projectors 11-20 are connected via signal lines 61-70 with the central control unit 60, which ensures that the projection surfaces 71 and 72, 74 and 75 as well as 75 and 76 shown here as overlapping, are in fact not overlapping and that no gaps occur between the projection surfaces as shown in FIG. 2 between the projection surfaces 73 and 74.

Thus, the three-dimensional panoramic screen 8 can be completely irradiated from the rear-side 31 by the projectors 11-20 with images without overlapping or gaps or transitions. The projectors 11-20 can map various image elements onto the associated projection surfaces 71-80, wherein in particular actual values of vehicle systems and control elements of vehicle functions are projected. For example, it is possible to project actual values of safety systems such as a tire-pressure monitoring device, a gradiometer, an inclinometer or a parking assistant onto one of the projection surfaces 71-80.

Control elements in the form of control points (not shown) may be provided on the panoramic screen 8 and actuated for calling up functional areas such as for comfort, for safety or for infotainment. Examples of such imaging and control elements may be for heating, venting, an air conditioning system, seat adjustment, seat heating or seat ventilation, an electric window lifter, electrically adjustable external mirrors, an audio system, a DVD video system, a tuner of a DAB system, a mini disc, a MP3, DVD or audio player. Furthermore, navigation systems, ESP systems or the like can be activated and adjusted or controlled on the panoramic screen by touching the relevant contact points. Also information from a digital traffic system, an internet system, a television system or a digital travel guide as well as a telephone system can be displayed as elements or as values in descriptive symbols on the projection surfaces 71-80. Furthermore, it is possible to display actual states of imaging and control elements of special vehicles, such as of a taximeter, an additional searchlight, a siren, a speed monitoring device or the like, on the projection surfaces 71 to 80 of the panoramic screen.

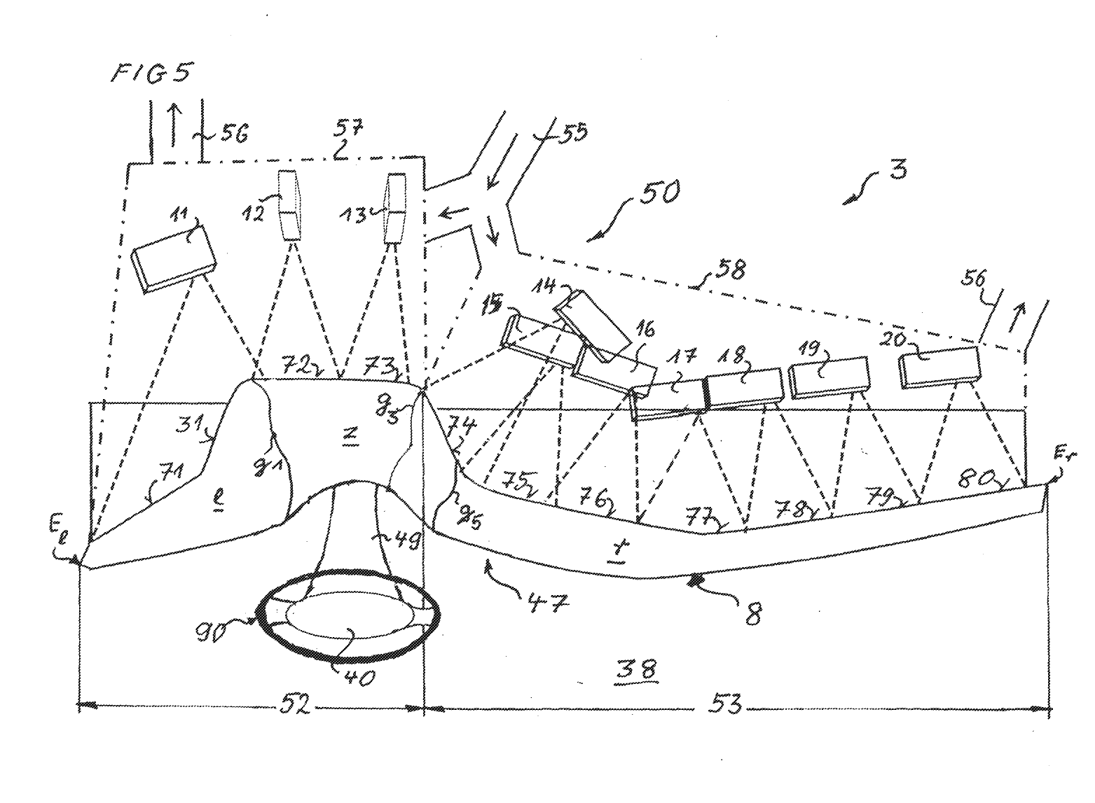

Physical control elements can thus be advantageously replaced by virtual control elements according to the present disclosure. To this end these virtual control elements are projected according to the present embodiments onto predefined masked sections of the projection surfaces 71-80 of the panoramic screen 8. Exemplary embodiments for such projection surfaces with images and control elements are explained in detail further below with reference to FIGS. 5 to 7. The projected images, graphics, control elements or pictures need not mandatorily be provided in the form of one mask, but several masks may be provided in a magazine of the system or in stores of one of the projectors 11-20 or in stores of the control unit 60. Depending upon the application it is possible to automatically use the light source of a projector for an image of the application function. Alternatively, image production on the panoramic screen may be implemented in various ways, and individual image elements can include different forms and colors, wherein each vehicle function or vehicle application may e.g. have a certain color assigned to it. This improves the ergonomics for the driver and significantly supports the operability of the vehicle.

In addition, the graphic images of the control elements can be altered such that the user receives direct feedback for his entry. For example, if the blower is adjusted by touching a corresponding contact point, the virtual control element can control the central control unit 60 of the projectors 11-20 in such a way that the respective blower stage and temperature setting are displayed on one of the projection surfaces 71-80. Moreover, optical detection devices may be used which, like contact points, can detect and evaluate an entry without making contact. In comparison to optical or haptic detection of an entry, contact-sensitive control elements are advantageous. For example, activation, control or evaluation can be effected by a change in pressure or by an electromagnetic, in particular capacitive change in the area of the control element. The projection surfaces 71-80 may include either a smooth surface without haptic feedback or a structured surface with haptic feedback at the contact points.

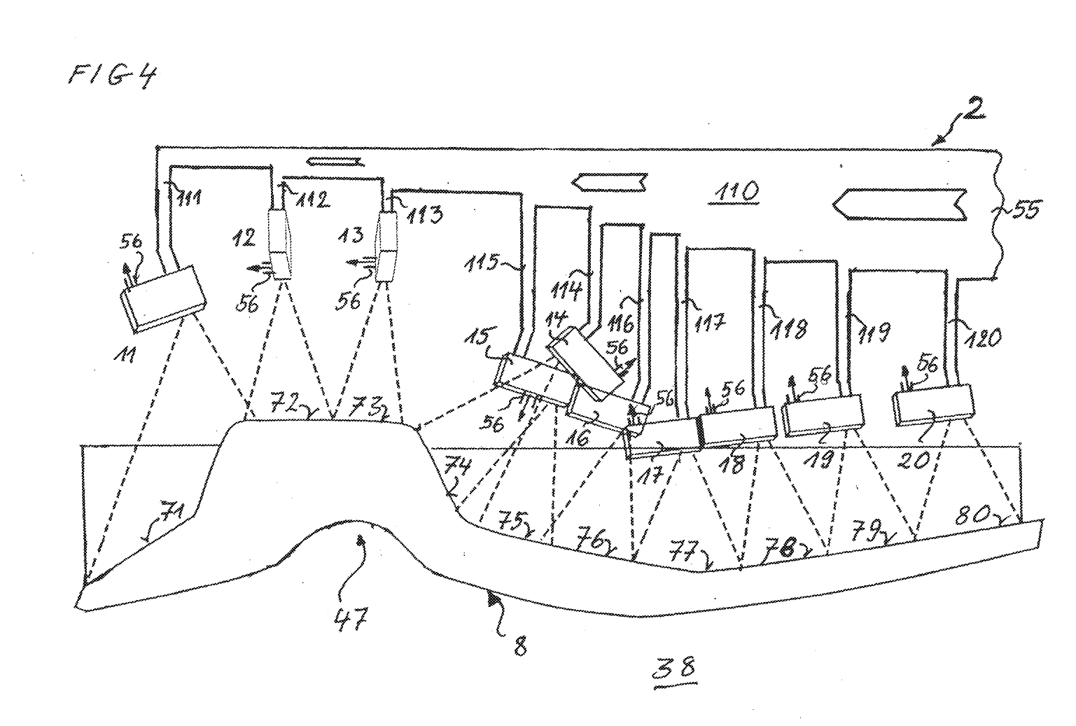

FIG. 4 shows a schematic housing design of a panorama projection unit 2 according to a second embodiment of the present disclosure. Each projector 11-20 has its own separate housing, which is supplied via its cooling air feed line 111-120 with cooling air for the respective projector 11-20. The cooling air enters a cooling air channel 110 via a cooling air inlet 55 and is exhausted into the environment from cooling air outlets 56 respectively associated with each projector 11-20. The cooling air inlet 55 is connected directly with the air conditioning system of the vehicle so that a uniform supply of cooling air for each of the cooling air feed lines 111 to 120 is ensured. Instead of the cooling air channel shown here with a narrowing cross-section after each branch-off of one of the cooling air feed lines 111-120, a cooling air distributor head is possible, with flexible hose connections coming therefrom as cooling air feed lines 111-120 which lead to the individual housings of projectors 11-20.

FIG. 5 shows a schematic view of a panorama projection unit 3 according to a further embodiment of the present disclosure. FIG. 5 shows the area of a steering column 49 for the driver with a steering wheel 90 and a first front airbag 40 in the center of the steering wheel 90 at the end of the steering column 49. Seen in driving direction in the vehicle interior space 38, there then follows the front area 47 with the panoramic screen 8, which in this embodiment may be separated along the border line g₃, and includes two adjacently arranged housing modules 57 and 58, which together with the associated projectors 11-13 and 14-20 and the parameter screen parts Eₗ- g₃ and g₃-Eᵣ form a first slide-in cassette 52 and a second adjacent slide-in cassette 53, respectively.

The housing module 57 encompasses a group of projectors 11, 12 and 13, which cover the left-hand area (l) and the central area (z) of the panoramic screen 8. A second housing module 58 includes a group of projectors 14-20 and covers the right-hand area (r) of the panoramic screen 8. The housing modules 57 and 58 ensure intensive cooling of the projectors 11-20 via a cooling air inlet 55 which divides into two forks, one going to the first housing module 57 and the other going to the second housing module 58. Both the first housing module 57 and the second housing module 58 have their own cooling air outlet 56. These two housing modules 57 and 58 with their associated projectors and their panoramic screen regions may be designed as two adjacently arranged cassettes which can be fitted as cassette units 52 and 53 into the front area 47 of a vehicle and electrically connected accordingly. The division into two cassettes ensures that the projectors do not overheat, wherein the cooling air inlet 55 is connected to an air conditioning system of the vehicle.

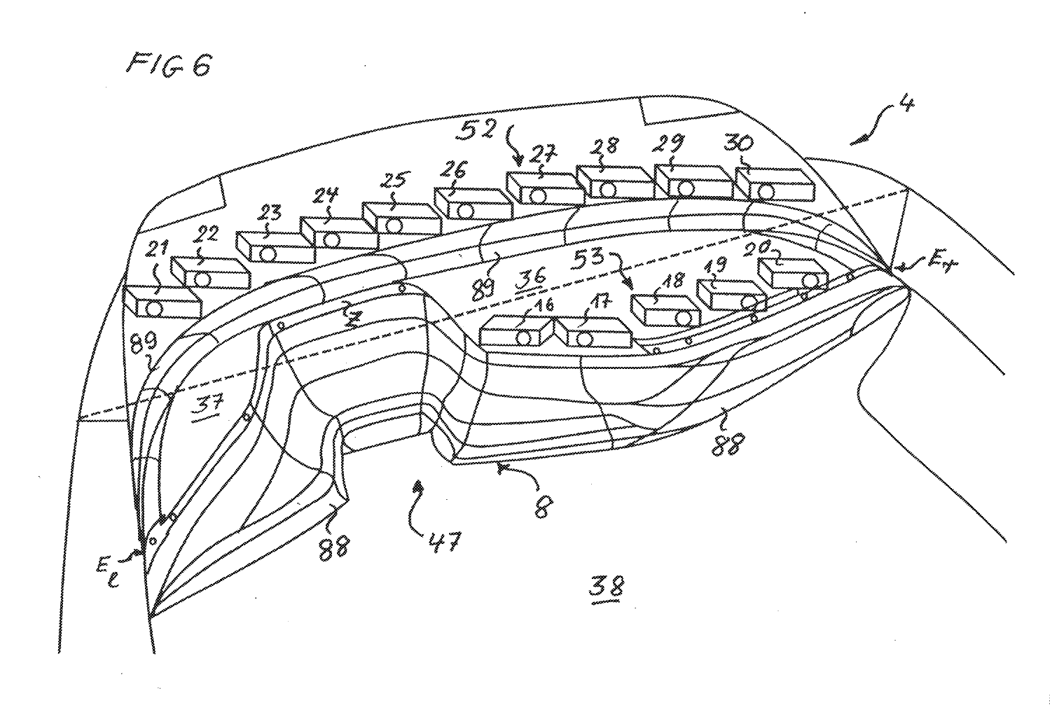

FIG. 6 shows a schematic view of a panorama projection unit 4 according to a further embodiment. This panorama projection unit 4 also includes two groups of projectors, a lower group of projectors including projectors 16-20, and an upper group of projectors including projectors 21-30. The lower group of projectors 16-20 is directed at a lower panoramic screen region 88 of the panoramic screen 8, and the upper group of projectors 21 to 30 is directed at an upper panoramic screen region 89. The upper panoramic screen region 89 and the lower panoramic screen region 88 are arranged spatially offset relative to one another and connected with each in the central area (z) as well as at their left-hand end Eₗ and their right-hand end Eᵣ. The in-between areas may be arranged horizontally and can thus be used as storage surface 36 and surface 37, as will be explained further with reference to FIGS. 5 to 7.

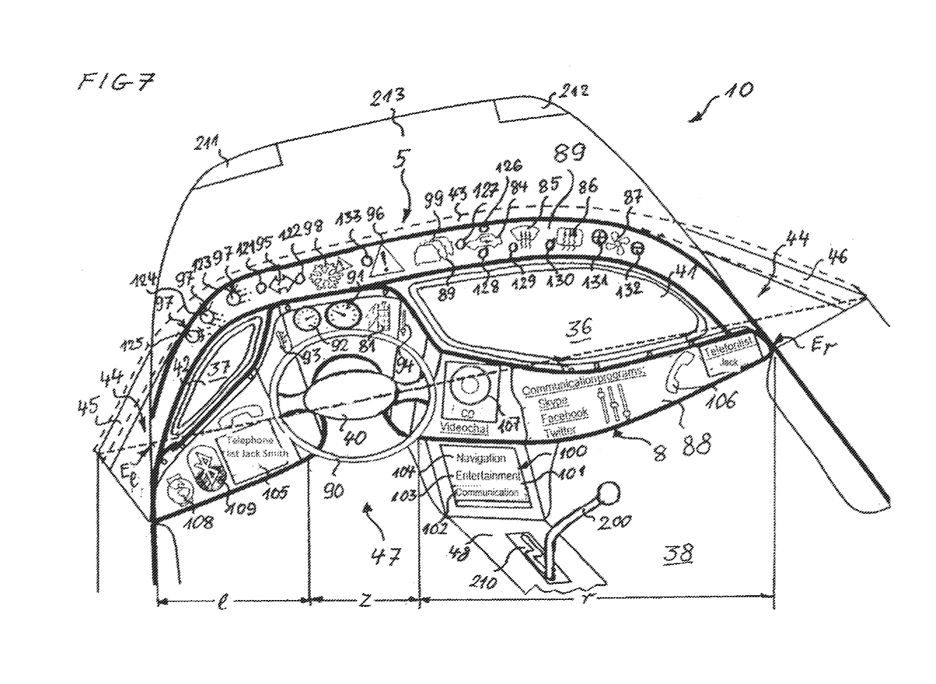

FIG. 7 shows a schematic perspective view of a panorama projection unit 5 according to a further embodiment with an “information center” including images and control elements of a communication system. To this end FIG. 5 schematically shows, in the front area 47 of the vehicle 10, headlights 211 and 212 and a car hood 213. A transition between the car hood 213 and a windscreen 44 indicated by a broken line is formed by windscreen wiper devices (not shown). A cross-member 43 belonging to the chassis of the vehicle 10 forms a stable transition from an engine area to the area of the windscreen 44. The lateral limitation of the windscreen 44 is formed by a left-hand A-column 45 and a right-hand A-column 46, so that the windscreen 44 reaches as far as a roof edge (not shown) which is indicated again by a broken line as the upper limitation of the windscreen in FIG. 7.

In this peripheral area 47 of the interior of the vehicle 38 is arranged a gear lever 200 with corresponding shifting gate 210 on a center console 48. Further, FIG. 7 shows a combination element 100 at the transition from the center console 48 to the panoramic screen 8. The panoramic screen 8 here includes a lower panoramic screen region 88 and an upper panoramic screen region 89. The upper panoramic screen region 89 arranged further forward is connected with the lower panoramic screen region 88 in the central area of the panoramic screen 8 and at the left-hand end Eₗ and the right-hand end Eᵣ.

As already shown in FIG. 6, the upper panoramic screen region 89 and the lower panoramic screen region 88 are arranged horizontally offset relative to each other thereby forming two storage surfaces 36 and 37 in between, beneath which two front airbags 41 and 42 may be arranged. The front airbag 41 underneath the covering 36 is for the protection of the passenger, while the front airbag 42 underneath the covering 37 supports the central front airbag 40 for the driver.

As shown in FIG. 7, the combination instrument 100 forms a contact-sensitive screen with a menu selection 101 which is electrically coupled, and interacts, with the central control unit shown in FIG. 3 and, in the embodiment shown in FIG. 7, calls up a communication information system 102 so that symbols, characters and letterings appear in the left-hand area (l) of the lower panoramic screen region 88 and in the right-hand area (r) of the lower panoramic screen region 88 for use of the communication information system 102.

The upper panoramic screen region 89 has, for example, standard indicators and possible contact points 121-133 arranged on it, which can be of help while the vehicle is travelling. In the central area (z), images of a speedometer 91, a tachometer 92, a coolant temperature indicator 93 and a fuel level indicator are provided. The central area may additionally show a battery status image 81, which in particular is of advantage for hybrid vehicles and electric vehicles.

In the upper panoramic screen region 89, lighting levels 97 are provided close to the driver, which additionally include contact point 123 for high beam, contact point 124 for low beams and contact point 125 for fog light. Furthermore, contact points 121 for flashing left and 122 for flashing right are provided within easy reach for the driver, together with an image of a flashing light indicator 95. The program of the central control unit is able to change both the images in this area and to re-assign or redefine individual contact points.

Furthermore, provision is made in this embodiment of the present disclosure for a black ice warning 98 to light up centrally and for switching a warning flashlight indicator 96 off and on, which can be initiated with the aid of a contact point 133. Moving further to the right in this embodiment according to FIG. 7, the upper panoramic screen region 89 includes a congestion warning indicator 99 and finally an air circulation control 84 with three contact points. Contact point 127 is used for activating the air circulation function. Contact point 126 is used for starting upwardly directed ventilation. Contact point 128 is used for starting downwardly directed ventilation into the foot area.

Further, the upper panoramic screen region 89 shows, moving towards the right in direction of the passenger, an image of a front screen heater 85 and a rear screen heater 86, which can be activated with the aid of contact points 129 and 130. It is possible to provide additional switching facilities by means of physical pressure and/or rocker switches in the area of the steering column.

Further, a symbol for a blower 87 is provided in FIG. 7 on the right-hand side, which includes a contact point 131 for increasing blower speed and a contact point 132 for reducing blower speed. Although both the arrangement and the assignment of the control elements and the arrangement and assignment of the image symbols can be changed by the central computer unit with the aid of the projectors, the distributions and images on the upper panoramic screen part 89 may remain unchanged. The same applies to the central area above the steering wheel or above the steering column, such as the speed indicator 91, the engine rev counter indicator 92, the coolant temperature indicator 93 and the fuel level indicator 94.

The communication system 102 provides a possibility of external communication to both the driver with the telephone service 105 and its own telephone list, and to the passenger with the telephone service 106 and its own telephone list. Internet access 108 and a personal wireless network 109, for example via Bluetooth, are provided for the driver in the left-hand lower area (l) of the panoramic screen region 88. On the right-hand side of the lower panoramic screen region 88 access is provided for the passenger to a CD player 107 and to various communication programs or social networks such as Skype, Facebook, LinkedIn or Twitter. By making a selection on the combination instrument 100 via menu indication 101 further images and control elements of the left-hand area (l) and/or right-hand area (r) of the lower panoramic screen region 88 can be exchanged or altered.

While at least one exemplary embodiment has been presented in the foregoing detailed description, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-15. (canceled)

16. A panorama projection unit for a motor vehicle comprising:
a housing with a three-dimensional panoramic screen having a transparent panoramic pane; and
a plurality of projectors arranged in the housing such that the projectors are configured to project images onto a rear-side of the panoramic screen.

17. The panorama projection unit according to claim 16, wherein the housing has a width configured to fit within an internal front width of the vehicle, the housing being limited towards the vehicle interior space and finishes there.

18. The panorama projection unit according to claim 16, wherein the housing is configured as a slide-in cassette which at least partially forms a dashboard of the vehicle.

19. The panorama projection unit according to claim 16, wherein the transparent three-dimensional panoramic pane comprises a semi-transparent coating on a rear-side of the pane.

20. The panorama projection unit according to claim 16, further comprising a rack supporting the housing and providing vibration-isolated from the vehicle.

21. The panorama projection unit according to claim 16 wherein the housing comprises a cooling air inlet and a cooling air outlet.

22. The panorama projection unit according to claim 21 wherein the cooling air inlet of the housing is operably coupled to an air conditioning system.

23. The panorama projection unit according to claim 16 wherein the housing comprises at least two housing modules configured to be combined in a modular manner.

24. The panorama projection unit according to claim 23, further comprising a first housing module having at least one projector and a first modular part of the panoramic screen, and a second housing module having at least one projector and a second modular part of the panoramic screen.

25. The panorama projection unit according to claim 24, wherein the first housing module includes a first plurality of projectors forming a first projector row, and the second housing module includes a second plurality of projectors forming a second projector row, wherein the first housing module is are arranged above the second housing module, and wherein the first projector row is configured to projects images onto an upper panoramic screen region, and the second projector row is configured to project images onto a lower panoramic screen region.

26. The panorama projection unit according to claim 25, wherein the lower panoramic screen region is partially spatially set back relative to the upper panoramic screen region such that at least one horizontal storage surface is formed between the upper and lower panoramic screen regions.

27. The panorama projection unit according to claim 26, wherein at least one front airbag is arranged underneath the at least one horizontal storage surface.

28. The panorama projection unit according to claim 16, wherein the projectors comprise at least one of light diodes, laser diodes, light diode arrays and laser diode arrays.

29. The panorama projection unit according to claim 16, wherein the panoramic screen is configured to be fixed between a cross-member of the windscreen (44) and a left-hand A-column and a right-hand A-column of a front area in the vehicle, and wherein the plurality of projectors are arranged on a rack configured to be anchored in a vibration-isolated manner between the cross-member and the left-hand and right-hand A-columns.

30. A motor vehicle in combination with the panorama projection unit according to claim 16.
